(19) United States
(12) Patent Application Publication
(10) Pub. No.: US 2011/0292419 A1
(43) Pub. Date: Dec. 1, 2011

(54) IMAGE FORMING APPARATUS

(75) Inventor: Kunihiro Shibuya, Kanagawa-ken (JP)

(73) Assignees: TOSHIBA TEC KABUSHIKI KAISHA, Tokyo (JP); KABUSHIKI KAISHA TOSHIBA, Minato-ku (JP)

(21) Appl. No.: 13/115,306

(22) Filed: May 25, 2011

Related U.S. Application Data
(60) Provisional application No. 61/348,352, filed on May 26, 2010.

(51) Int. Cl. H04N 1/60

(52) U.S. Cl. 358/1.9

(57) ABSTRACT

According to one embodiment, an image forming apparatus includes a printer section and a control section which controls the printer section. The control section controls a developing roller driving section to stop the rotation of a developing roller when an image on a recording medium is erased when the printer section operates in an image erasing mode, alternatively, the control section includes an image formation fee counter and an erasure fee counter provided separately from the image formation fee counter.

### CROSS-REFERENCE TO RELATED APPLICATIONS

This application is based upon and claims the benefit of priority from U.S. Provisional Application No. 61/348,352, filed on May 26, 2010; the entire contents of which are incorporated herein by reference.

### FIELD

Embodiments described herein relate generally to an image forming apparatus to which a decolorizable developer is applied.

### BACKGROUND

There are known an image forming apparatus which forms an image using a decolorizable toner, and an image erasing apparatus which can convert an image from a colored state to a decolorized state. When a decolorizable toner is used, the toner is decolorized by cleaving the bond between a dye and a color developing agent through heating. In a conventional image erasing apparatus, in order to decolorize a toner image, for example, it is necessary to heat a sheet to 120 to 150° C. for about 2 hours.

Since decolorization of an image requires heating for about 2 hours as described above and also requires cooling for about 1 hour, and for other reasons, an image forming apparatus and an image erasing apparatus are provided as separate apparatuses so far.

However, the total cost is increased when an image erasing apparatus is purchased and installed in addition to an image forming apparatus. Therefore, if a toner which can be decolorized in a short time can be used, it is intended to reduce the installation cost by combining an image forming apparatus and an image erasing apparatus, and also there is a need to constitute an apparatus such that an image formation function and an image erasure function can be integrated into the same apparatus.

### DESCRIPTION OF THE DRAWINGS

FIG. 1 is an exemplary view showing an image forming apparatus according to an embodiment;

FIG. 2 is an exemplary view showing a screen displayed on a control panel;

FIG. 3 is an exemplary block diagram showing a first embodiment of a control system of an image forming apparatus;

FIG. 4 is an exemplary block diagram showing a second embodiment of a control system of an image forming apparatus;

FIG. 5 is a flow diagram showing an exemplary operation of a fee processing section; and

FIG. 6 is a flow diagram showing another exemplary operation of a fee processing section.

### DETAILED DESCRIPTION

In general, according to one embodiment, an image forming apparatus includes a printer section and a control section which controls the printer section. The printer section includes a photoreceptor, a developing roller which supplies a toner to the surface of the photoreceptor, a developing device which develops an electrostatic latent image formed on the photoreceptor to form a toner image, a developing roller driving section which rotationally drives the developing roller, a transfer section which transfers the toner image onto a recording medium, and a fixing-heating section which heats the toner image on the recording medium. The control section sets an operation mode such that when an erasing operation is designated, the printer section operates in an image erasing mode to erase an image on a recording medium, and controls the developing roller driving section to stop the rotation of the developing roller in the image erasing mode.

According to a second embodiment, the image forming apparatus includes an image formation fee counter and an erasure fee counter provided separately from the image formation fee counter. The image formation fee counter determines a fee based on the image forming conditions and the number of recording media on which an image is formed by the operation of the image forming apparatus in an image forming mode. The erasure fee counter determines a fee based on the erasing conditions and the number of recording media on which an image is erased by the operation of the image forming apparatus in an image erasing mode.

Hereinafter, embodiments of the image forming apparatus will be described in detail with reference to the accompanying drawings.

Incidentally, in the respective drawings, the same components are denoted by the same reference numerals and signs.

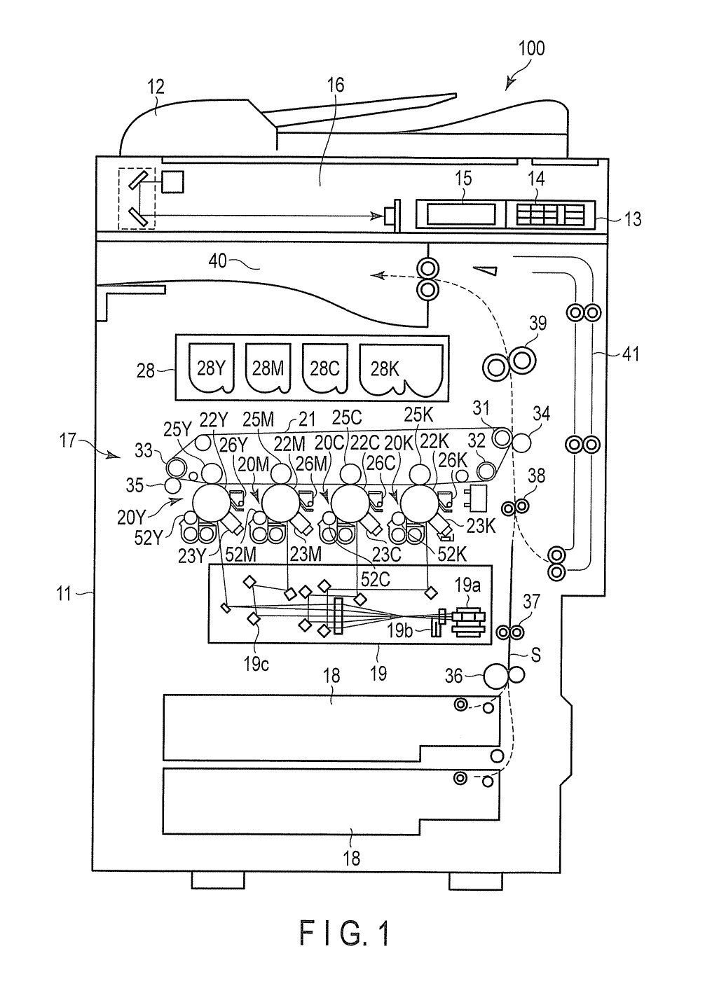

FIG. 1 is a front view showing one embodiment of the image forming apparatus.

In FIG. 1, the reference numeral 100 denotes an image forming apparatus, which is, for example, an MFP (multifunction peripheral) as a complex machine, a printer, a copier, or the like. In the following description, an MFP is described as an example of the image forming apparatus.

A document table (not shown) is provided in an upper part of a main body 11 of the MFP 100, and an automatic document feeder (ADF) 12 is openably and closably provided on the document table. Further, a control panel 13 is provided in an upper part of the main body 11. The control panel 13 includes an operation section 14 including various keys and a display section 15 of a touch panel type.

A scanner section 16 is provided below the ADF 12 in the main body 11. The scanner section 16 scans a document fed by the ADF 12 or a document placed on the document table and generates image data. Further, a printer section 17 is provided in the center in the main body 11, and a plurality of cassettes 18 which store sheets of various sizes are provided in a lower part of the main body 11.

The printer section 17 includes photoreceptor drums, lasers, and the like, and processes image data scanned by the scanner section 16 or image data created by a PC (personal computer) or the like and forms an image on a sheet (details will be described later).

The sheet having an image formed thereon by the printer section 17 is discharged to a paper discharge section 40. The printer section 17 is, for example, a color laser printer of a tandem system, and scans a photoconductor with a laser beam from a laser exposing device 19 and generates an image.

The printer section 17 includes image forming sections 20Y, 20M, 20C, and 20K for respective colors of yellow (Y), magenta (M), cyan (C), and black (K). The image forming sections 20Y, 20M, 20C, and 20K are arranged in parallel below an intermediate transfer belt 21 from an upstream side to a downstream side.

The printer section 17 including the image forming sections 20Y, 20M, 20C, and 20K is shown in FIG. 3 in enlargement. Since the image forming sections 20Y, 20M, 20C, and 20K have the same structure, the image forming section 20Y will be described below as a representative image forming section.

The image forming section 20Y has a photoreceptor drum 22Y which is a photoreceptor, and around the photoreceptor drum 22Y, an electrifying charger 23Y, a developing device 24Y, a primary transfer roller 25Y, a cleaner 26Y, a blade 27Y, and the like are arranged along the rotating direction t of the photoreceptor drum 22Y. The electrifying charger 23Y of the image forming section 20Y uniformly charges the entire surface of the photoreceptor drum 22Y.

An area at an exposing position of the photoreceptor drum 22Y is irradiated with a yellow laser beam from the laser exposing device 19 to form an electrostatic latent image on the photoreceptor drum 22Y.

The developing device 24Y supplies a two-component developer composed of a yellow toner and a carrier to the photoreceptor drum 22Y using a developing roller to which a developing bias is applied to form a toner image. The cleaner 26Y removes a residual toner on the surface of the photoreceptor drum 22Y using the blade 27Y.

Above the respective image forming sections 20Y, 20M, 20C, and 20K, toner cartridges 28 (FIG. 1) which supply a toner to the developing devices 24Y, 24M, 24C, and 24K are provided, respectively. The toner cartridges 28 include toner cartridges 28Y, 28M, 28C, and 28K for the respective colors of yellow (Y), magenta (M), cyan (C), and black (K), which are adjacent to one another.

The intermediate transfer belt 21 cyclically moves, and for example, semi-conductive polyimide is used for the intermediate transfer belt 21 from the viewpoint of heat resistance and abrasion resistance. The intermediate transfer belt 21 is reeved around a driving roller 31 and driven rollers 32 and 33 and faces and is in contact with the photoreceptor drums 22Y to 22K. A primary transfer voltage is applied to the intermediate transfer belt 21 at a position facing the photoreceptor drum 22Y by the primary transfer roller 25Y to primarily transfer the toner image on the photoreceptor drum 22Y onto the intermediate transfer belt 21.

A secondary transfer roller 34 is arranged facing the driving roller 31 around which the intermediate transfer belt 21 is reeved. When the sheet S passes between the driving roller 31 and the secondary transfer roller 34, a secondary transfer voltage is applied to the sheet S by the secondary transfer roller 34 to secondarily transfer the toner image on the intermediate transfer belt 21 onto the sheet S. A belt cleaner 35 is provided near the driven roller 33 of the intermediate transfer belt 21.

On the other hand, the laser exposing device 19 includes a polygon mirror 19a, an imaging lens system 19b, a mirror 19c, and the like, and scans a laser beam emitted from a semiconductor laser element in the axial direction of the photoreceptor drum 22.

Further, as shown in FIG. 1, a separation roller 36 which extracts the sheet S in the paper feed cassette 18, conveying rollers 37, and resist rollers 38 are provided between the paper feed cassette 18 and the secondary transfer roller 34. Further, a fixing device 39 is provided downstream of the secondary transfer roller 34.

The paper discharge section 40 and a reverse conveyance path 41 are provided downstream of the fixing device 39. The sheet S is discharged to the paper discharge section 40 from the fixing device 39. The reverse conveyance path 41 is used when duplex printing is performed and is configured to reverse the sheet S and then guide the sheet in the direction of the secondary transfer roller 34.

Subsequently, operations of the image forming apparatus 100 shown in FIG. 1 will be described. When image data is input from the scanner 16, PC, or the like, images are sequentially formed in the image forming sections 20Y to 20K.

When the image forming section 20Y is described as an example, the photoreceptor drum 22Y is irradiated with a laser beam corresponding to yellow (Y) image data and an electrostatic latent image is formed thereon. Further, the electrostatic latent image on the photoreceptor drum 22Y is developed by the developing device 24Y, whereby a yellow (Y) toner image is formed.

The photoreceptor drum 22Y comes into contact with the rotating intermediate transfer belt 21 and primarily transfers the yellow (Y) toner image onto the intermediate transfer belt 21 using the primary transfer roller 25Y. After the toner image is primarily transferred onto the intermediate transfer belt 21, a residual toner on the photoreceptor drum 22Y is removed by the cleaner 26Y and the blade 27Y. Accordingly, the photoreceptor drum 22Y can be used for the subsequent image formation.

In the same manner as the process for forming the yellow (Y) toner image, magenta (M), cyan (C), and black (K) toner images are formed by the image forming sections 20M to 20K. The respective toner images are sequentially transferred onto the intermediate transfer belt 21 at the same position where the yellow (Y) toner image is transferred. The yellow (Y), magenta (M), cyan (C), and black (K) toner images are transferred in a superimposed manner onto the intermediate transfer belt 21, whereby a full-color toner image can be obtained.

The full-color toner image on the intermediate transfer belt 21 is secondarily transferred onto the sheet S collectively by a transfer bias of the secondary transfer roller 34. The sheet S is fed from the paper feed cassette 18 to the secondary transfer roller 34 synchronously with the full-color toner image on the intermediate transfer belt 21 reaching the secondary transfer roller 34.

The sheet S having the toner image secondarily transferred thereto reaches the fixing device 39 and the toner image is fixed thereon by heating. The sheet S having the toner image fixed thereon is discharged to the paper discharge section 40. On the other hand, after the secondary transfer is completed, a residual toner on the intermediate transfer belt 21 is cleaned by the belt cleaner 35.

Incidentally, for example, by supplying a decolorizable toner to the toner cartridge 28K or the like in place of the black toner, a toner image can be formed with the decolorizable toner.

In this embodiment, as the decolorizable toner, a capsule-type thermally decolorizable toner prepared by the following chemical method can be used.

### (1) Preparation of Finely Pulverized Binder Resin Dispersion Liquid

As a binder resin, a Pes resin is used. The Pes resin, an anionic emulsifying agent, and a neutralizing agent are treated with a high-pressure homogenizer, whereby a finely pulverized binder resin dispersion liquid is prepared.

### (2) Preparation of Finely Pulverized WAX Dispersion Liquid

A finely pulverized wax dispersion liquid is prepared using rice wax in the same manner as the above resin.

### (3) Preparation of Toner

Leuco dye: CVL (crystal violet lactone)

Color developing agent: benzyl 4-hydroxybenzoate

Temperature control agent: 4-benzyloxyphenylethyl laurate

The above components are melted by heating. Then, the resulting material is encapsulated by a known coacervation method. The resulting encapsulated color material and the toner binder resin dispersion liquid, and the wax dispersion liquid are aggregated and fused using aluminum sulfate [Al₂(SO₄)₃], followed by washing and drying, whereby toner particles are obtained. To the surfaces of the toner particles, an additive is attached as needed, whereby a toner can be obtained. Hereinafter, this toner is called a capsule-type decolorizable toner.

The capsule-type decolorizable toner to be used in this embodiment can be prepared such that the encapsulated color material is contained therein in an amount of, for example, 10 wt % of the total amount of the toner particles.

When an image is formed using the decolorizable toner, for example, a two-component developer which is a mixture of the above-mentioned capsule-type decolorizable toner having a volume average particle diameter of from 5 to 12 μm with a magnetic carrier having a volume average particle diameter of from 30 to 80 μm can be prepared. By applying the thus obtained two-component developer to the image forming apparatus 100, an image can be formed using the decolorizable toner.

The true specific gravity of the capsule-type decolorizable toner is in a range of about 0.9 to 1.2 g/cm³. By heating the decolorizable toner image formed on a sheet to, for example, 90° C. or higher, the bond between the dye and the color developing agent in the capsule is cleaved by heating, whereby the color of the toner image can be erased.

In this embodiment, by using the image forming apparatus 100, the decolorizable toner image can be erased as follows.

The sheet S having an image formed thereon using the decolorizable toner is placed in the paper feed cassette unit 18 for recycling the sheet by erasing the color of the toner image after completion of the use thereof.

A user performs an operation for erasing the image. The sheet S having an image formed thereon may be placed in a specific cassette unit 18 or a manual feed unit.

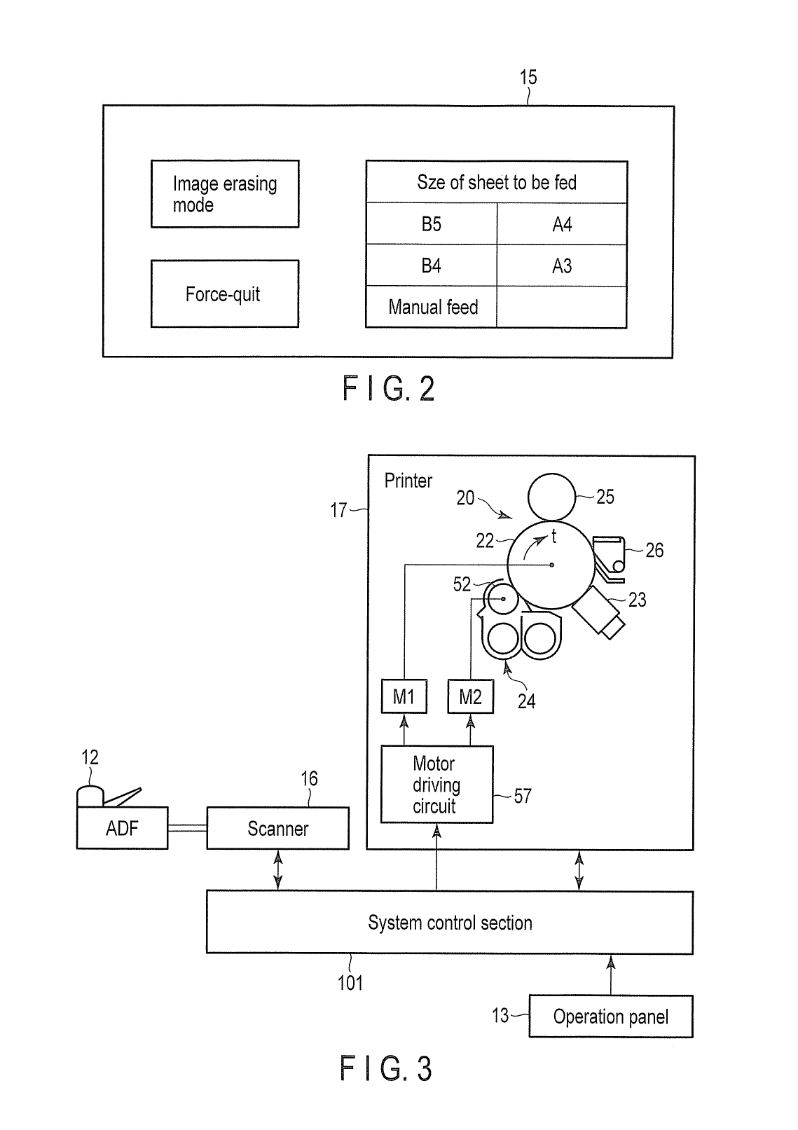

FIG. 2 is an exemplary view showing an image erasing operation screen displayed on the control panel 13 shown in FIG. 1.

The user presses down an image erasing mode button on the image erasing operation screen in a display section 15, and further designates a cassette storing the sheet S to be recycled selected from the cassettes 1 to 4 corresponding to the size of B5, A4, B4, and A3, respectively, and a manual feed unit as the size of the sheet to be fed. Then, when the user presses a start button provided in the operation section 14 in the control panel 13, the erasing operation is started. Incidentally, the image erasing operation screen is not limited to this structure, and the screen may be configured such that an operation button for erasing an image is integrated into a conventional operation screen. Further, the apparatus may be configured such that the sheet S to be recycled is extracted from a specific cassette without designating the cassette.

FIG. 3 is a block diagram showing a first embodiment of a control system of the image forming apparatus shown in FIG. 1, and mainly shows a control system of a developing device.

In FIG. 3, the reference numeral 101 denotes a system control section, which includes a CPU, a RAM, a ROM, and the like, and controls the operation of the entire image forming apparatus 100. To the system control section 101, the control panel 13, the scanner section 16, and the printer section 17 are connected, respectively.

The image forming section 20 in the printer section 17 includes the photoreceptor drum 22 which is a photoreceptor, and around the photoreceptor drum 22, the electrifying charger 23, the developing device 24, the primary transfer roller 25, the cleaner 26, and the like are arranged.

A motor M1 which drives the photoreceptor drum 22 and a motor M2 which drives a developing roller 52 are controlled by a motor driving circuit 57, and the motor driving circuit 57 is controlled by the system control section 101.

In the image erasing mode, the system control section 101 stops the rotation of the developing roller 52.

Further, in this image erasing mode, the photoreceptor drum 22 can be driven in the direction of the arrow t at a “second sheet conveying speed” (for example, a peripheral speed of 21 mm/sec) which is slower than a “first sheet conveying speed” in the image forming mode (for example, a peripheral speed of 215 mm/sec). In the image erasing mode, an electrostatic latent image corresponding to the image information by the laser exposing device 19 is not formed on the photoreceptor drum 22. That is, the sheet S passes through the same route as that in the case of forming an image described above and is conveyed to the fixing device 39.

In the image erasing mode, the fixing device 26 also conveys the sheet at the “second sheet conveying speed” (a peripheral speed of 21 mm/sec) while performing fixation by heating and/or pressing. At this time, the surface temperature of the fixing roller of the fixing device 39 is 160° C., which is the same as that in the case of forming an image. By heating the sheet at a conveying speed slower than that in the image forming process, the toner image on the sheet is heated to 90° C. or higher, whereby the toner image can be decolorized due to the instantaneous decolorizing property of the capsule-type decolorizable toner.

The above-mentioned operation is continued until no sheets remain in the paper feed cassette unit 20. For example, when it is detected that no sheets remain in the paper feed cassette unit 20 and also the last sheet is discharged from the apparatus, the mode is automatically restored to a predetermined mode other than the image erasing mode (such as an ordinary image forming mode, a Ready mode, or an energy saving mode). With such a configuration that the image erasing mode is automatically terminated and restored to a predetermined mode other than the image erasing mode (such as an ordinary image forming mode, a Ready mode, or an energy saving mode), it is possible to erase the color of the toner image on a plurality of sheets after completion of the use thereof by utilizing a time zone such as nighttime during which printing is generally hardly carried out.

Further, a force-quit button for forcibly terminating the image erasing mode can be added to the above-mentioned image erasing operation screen. When operating this button, the image erasing mode is terminated and is restored to a predetermined mode other than the image erasing mode (such as an ordinary image forming mode, a Ready mode, or an energy saving mode).

Incidentally, in the above embodiment, the fixing roller 27 is heated, however, the pressing roller 28 may also be heated. The sheet S is placed in the paper feed cassette 20 such that the surface of the sheet on which the decolorizable toner is printed is directly brought into contact with the fixing roller 27. However, the configuration is not limited thereto, and the sheet S may be placed in the paper feed cassette 20 such that the surface on the back of the sheet on which the decolorizable toner is printed is directly brought into contact with the fixing roller 27. By appropriately determining the presence or absence of heating by the fixing roller 27 and the pressing roller 28, the heating conditions such as a heating temperature, the conditions for the “second sheet conveying speed”, the thickness of the sheet, the type of the sheet, and the like, the image erasing mode independent of how to place the sheet in the paper feed cassette 20 can be set.

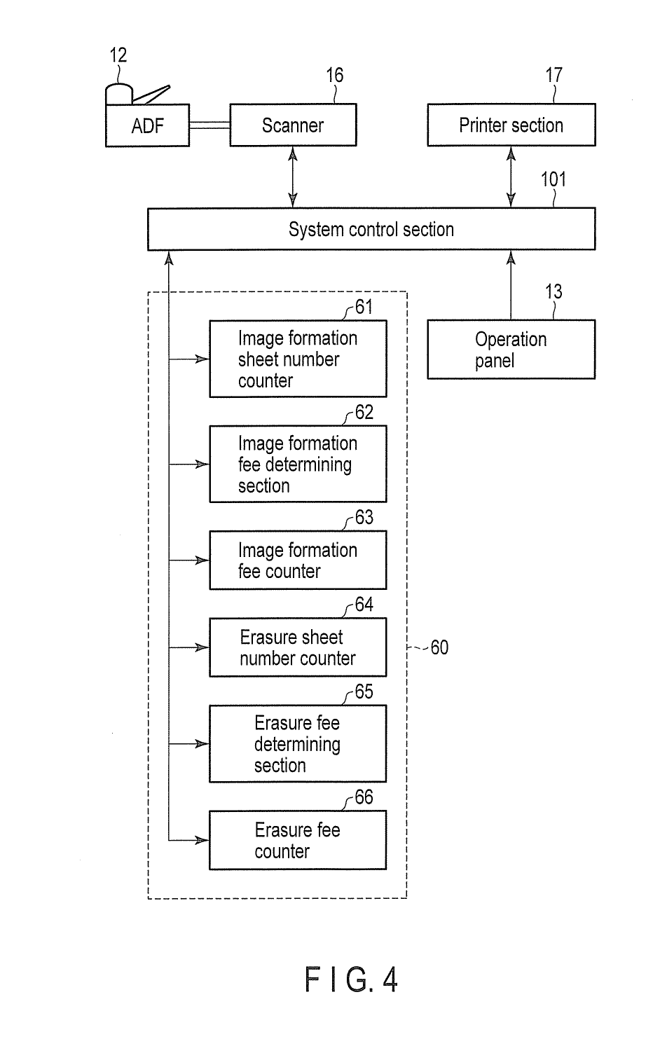

FIG. 4 is an exemplary block diagram showing a second embodiment of the control system of the image forming apparatus 100 shown in FIG. 1.

In FIG. 4, the apparatus has the same structure as in FIG. 3 except that the apparatus is further provided with a fee processing section 60.

Incidentally, it is optional whether or not the system control section 101 stops the rotation of the developing roller 52 in the image erasing mode.

The fee processing section 60 includes an image formation sheet number counter 61 which counts the number of sheets S on which an image is formed in the image forming mode, an image formation fee determining section 62 which determines an image formation fee based on the number of sheets counted by the image formation sheet number counter 61, an image formation fee counter 63 which counts the image formation fee determined by the image formation fee determining section 62, an erasure sheet number counter 64 which counts the number of sheets on which an image is erased in the image erasing mode, an erasure fee determining section 65 which determines an erasure fee based on the number of sheets counted by the erasure sheet number counter 64, and an erasure fee counter 66 which counts the erasure fee determined by the erasure fee determining section 65.

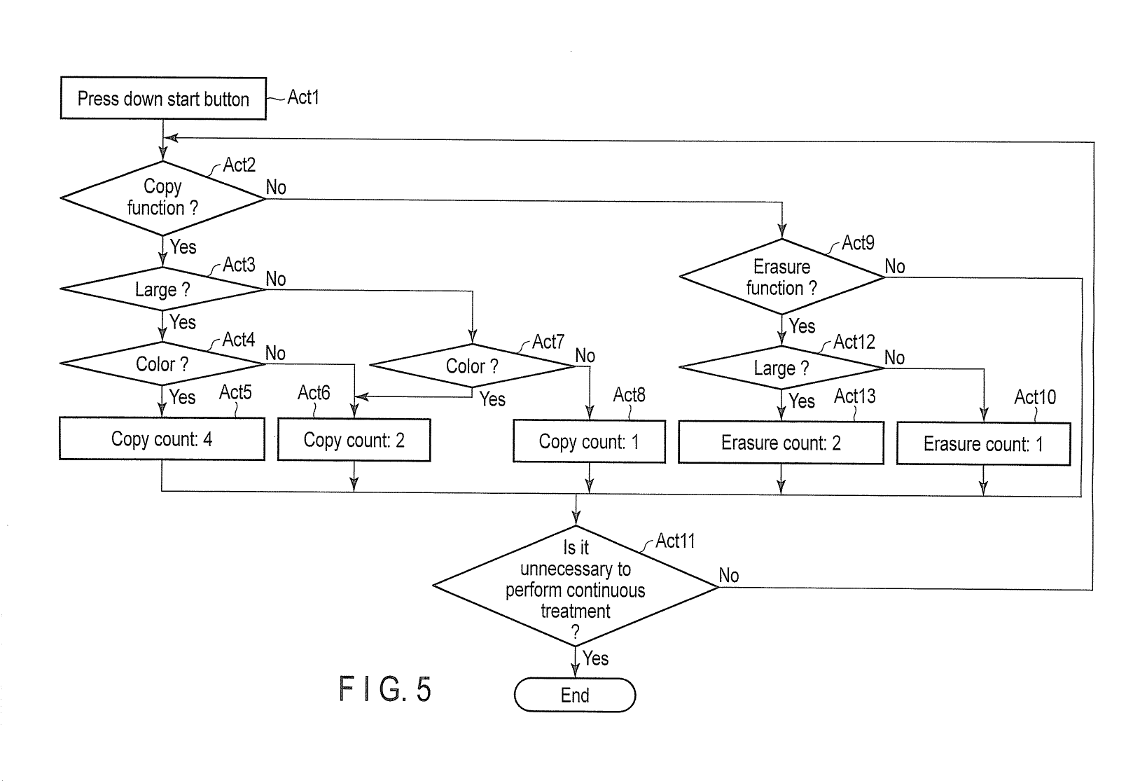

FIG. 5 is a flow diagram showing an exemplary operation of a fee processing section shown in FIG. 4.

As shown in FIG. 5, by pressing down a start button on the control panel 13, an operation is started (Act 1).

In the control panel 13, it is determined whether or not a user selects a copy function (Act 2), and when the user selects the copy function, subsequently, it is confirmed whether the size of an image to be copied is large or small (Act 3), and it is also confirmed whether an image to be copied is color or monochrome (Act 4 and Act 7). When the size is large and the image is color, based on the number (=1) of sheets counted by the image formation sheet number counter 61 and the information of the size and color of the image to be copied, the image formation fee determining section 62 determines the copy count to be 4, and the image formation fee counter 63 performs counting (Act 5). Further, when the size is large and the image is monochrome or when the size is small and the image is color, based on the number (=1) of sheets counted by the image formation sheet number counter 61 and the information of the size and color of the image to be copied, the image formation fee determining section 62 determines the copy count to be 2, and the image formation fee counter 63 performs counting (Act 6). When the size is small and the image is monochrome, based on the number (=1) of sheets counted by the image formation sheet number counter 61 and the information of the size and color of the image to be copied, the image formation fee determining section 62 determines the copy count to be 1, and the image formation fee counter 63 performs counting (Act 8).

On the other hand, in the control panel 13, when a user does not select a copy function, it is confirmed whether or not the user selects an erasure function (Act 9). When the user selects the erasure function, based on the number (=1) of sheets counted by the erasure sheet number counter 64, the erasure fee determining section 65 determines the erasure count to be 1, and the erasure fee counter 66 performs counting (Act 10).

Thereafter, if it is not necessary to continuously perform the subsequent image forming treatment or erasing treatment (Act 11), the operation is terminated. If it is necessary to continuously perform the subsequent image forming treatment or erasing treatment, it is determined whether or not the user selects the copy function (Act 2), and the same operation as described above is repeated.

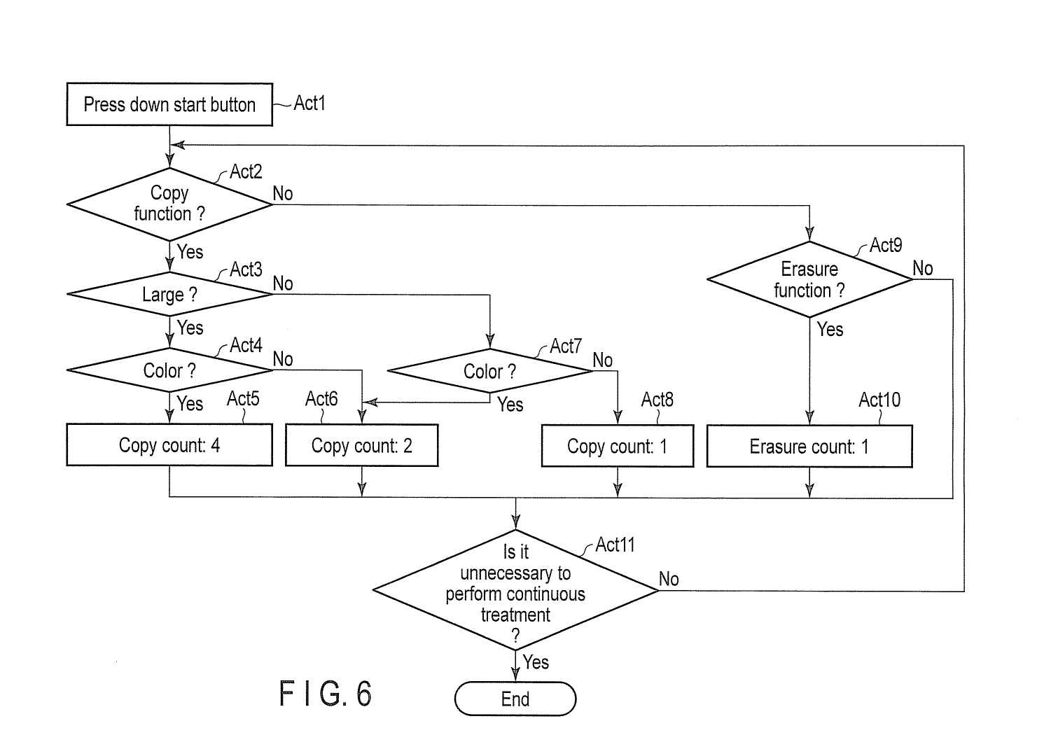

FIG. 6 is a flow diagram showing another exemplary operation of the fee processing section shown in FIG. 4.

The flow diagram shown in FIG. 6 is the same as that shown in FIG. 5 except for the following operations. In the control panel 13, when the user does not select the copy function, after it is confirmed whether or not the user selects the erasure function (Act 9), it is confirmed whether the size of an image to be erased is large or small (Act 12). When the size is large, based on the number (=1) of sheets counted by the erasure sheet number counter 64 and the information of the size of the image, the erasure fee determining section 65 determines the erasure count to be 2, and the erasure fee counter 66 performs counting (Act 13). When the size is small, based on the number (=1) of sheets counted by the erasure sheet number counter 64 and the information of the size of the image, the erasure fee determining section 65 determines the erasure count to be 1, and the erasure fee counter 66 performs counting (Act 10).

According to the above embodiments, an apparatus having both image formation function and image erasure function is provided. Therefore, it is possible to reduce the installation cost as compared with the case where an image forming apparatus and an image erasing apparatus are provided as separate apparatuses.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An image forming apparatus, comprising:
a printer section including:
a photoreceptor;
a developing device which includes a developing roller for supplying a toner to a surface of the photoreceptor and develops an electrostatic latent image formed on the photoreceptor to form a toner image;
a developing roller driving section configured to rotationally drive the developing roller;
a transfer section configured to transfer the toner image onto a recording medium; and
a fixing-heating section configured to heat the toner image on the recording medium; and
a control section which sets an operation mode such that when an erasing operation is designated, the printer section operates in an image erasing mode to erase an image on a recording medium, and which controls the developing roller driving section to stop the rotation of the developing roller in the image erasing mode.

2. The apparatus according to claim 1, wherein the recording medium on which an image is to be erased in the image erasing mode has a toner image formed with a thermally decolorizable toner containing an encapsulated color material containing at least a leuco dye and a color developing agent at a compositional ratio of from 10 to 30 wt %.

3. The apparatus according to claim 1, wherein the printer section is an image forming apparatus employing an electrophotographic system, and when an image is formed on the recording medium, a sheet conveying speed in the fixing-heating section is set to a first sheet conveying speed, and when an image on the recording medium is erased, a sheet conveying speed in the fixing-heating section is set to a second sheet conveying speed which is slower than the first sheet conveying speed, and the image is decolorized by heating the recording medium.

4. The apparatus according to claim 3, wherein a sheet interval when the image is decolorized by heating the recording medium at the second sheet conveying speed is longer than that when the image is formed at the first sheet conveying speed.

5. The apparatus according to claim 4, wherein the sheet interval when the image is decolorized by heating the recording medium at the second sheet conveying speed is at least 2 seconds.

6. The apparatus according to claim 1, wherein the printer section is an image forming apparatus employing an electrophotographic system, and when an image is formed on the recording medium, the temperature of the fixing-heating section is set to a first heating temperature, and when an image on the recording medium is erased, the temperature of the fixing-heating section is set to a second heating temperature which is lower than the first heating temperature, and the image is decolorized by heating the recording medium.

7. An image forming apparatus, comprising:
a printer section including:
a photoreceptor;
a developing device which includes a developing roller for supplying a toner to a surface of the photoreceptor and develops an electrostatic latent image formed on the photoreceptor to form a toner image;
a developing roller driving section configured to rotationally drive the developing roller;
a transfer section configured to transfer the toner image onto a recording medium; and
a fixing-heating section configured to heat the toner image on the recording medium;
a fee processing section including:
an image formation fee counter configured to count a fee determined based on the number of recording media on which an image is formed when the printer section operates in an image forming mode; and
an erasure fee counter configured to count a fee determined based on the number of recording media on which an image is erased when the printer section operates in an image erasing mode; and
a control section configured to control the printer section and the fee processing section.

8. The apparatus according to claim 7, wherein the recording medium on which an image is to be erased in the image erasing mode has a toner image formed with a thermally decolorizable toner containing an encapsulated color material containing at least a leuco dye and a color developing agent at a compositional ratio of from 10 to 30 wt %.

9. The apparatus according to claim 7, wherein the printer section is an image forming apparatus employing an electrophotographic system, and when an image is formed on the recording medium, a sheet conveying speed in the fixing-heating section is set to a first sheet conveying speed, and when an image on the recording medium is erased, a sheet conveying speed in the fixing-heating section is set to a second sheet conveying speed which is slower than the first sheet conveying speed, and the image is decolorized by heating the recording medium.

10. The apparatus according to claim 9, wherein a sheet interval when the image is decolorized by heating the recording medium at the second sheet conveying speed is longer than that when the image is formed at the first sheet conveying speed.

11. The apparatus according to claim 10, wherein the sheet interval when the image is decolorized by heating the recording medium at the second sheet conveying speed is at least 2 seconds.

12. The apparatus according to claim 7, wherein the printer section is an image forming apparatus employing an electrophotographic system, and when an image is formed on the recording medium, the temperature of the fixing-heating section is set to a first heating temperature, and when an image on the recording medium is erased, the temperature of the fixing-heating section is set to a second heating temperature which is lower than the first heating temperature, and the image is decolorized by heating the recording medium.

13. The apparatus according to claim 7, wherein the control section further has a function of setting an operation mode such that when an erasing operation is designated, the printer section operates in an image erasing mode to erase an image on the recording medium, and controlling the developing roller driving section to stop the rotation of the developing roller in the image erasing mode.
